(19) United States
(12) Patent Application Publication
(10) Pub. No.: US 2023/0043457 A1
(43) Pub. Date: Feb. 9, 2023

(54) AUTHENTICATION SYSTEM FOR AUTHENTICATION OF STUDENT SUBMISSIONS

(71) Applicant: Sikanai LLC, Park Hills, KY (US)

(72) Inventor: Wasi Khan, Gulistan-e-Jauhar (PK)

(73) Assignee: Sikanai LLC, Park Hills, KY (US)

(21) Appl. No.: 17/880,236

(22) Filed: Aug. 3, 2022

(30) Foreign Application Priority Data
Aug. 9, 2021 (PK) PK576/2021

(51) Int. Cl. G06F 21/31; G06F 40/40

(52) U.S. Cl. CPC G06F 21/31; G06F 40/40; G06F 2221/2103

(57) ABSTRACT

In accordance with one embodiment of the present disclosure, a method for author verification includes extracting, with a processor, text data from an electronic document to produce a plurality of sentences, extracting, with a natural language processing (NLP) tool, a plurality of keywords from the text data, selecting, with the processor, a sentence from the plurality of sentences based on the plurality of keywords, identifying, with the processor, a keyword of the sentence, wherein the keyword is included within the plurality of keywords, and transforming, with the processor and the NLP tool, the keyword into an authentication output provided for display to a user on an electronic display, the authentication output comprising one or more answer options based on the keyword and being selectable by the user via a user input device.

### CROSS REFERENCE TO RELATED APPLICATION

This application claims the benefit of Pakistan Application Serial No. 576/2021, provisionally filed Aug. 9, 2021 entitled “AUTHENTICATION SYSTEM FOR AUTHENTICATION OF STUDENT SUBMISSIONS”, and converted into a non-provisional filing on Mar. 18, 2022, the entireties of which is hereby incorporated by reference.

### TECHNICAL FIELD

The present disclosure relates to authentication systems, and more particularly to systems for authenticating the sender of a submission as the author of the submission.

### BACKGROUND

In the field of education, students are provided assignments by teachers to facilitate the students' education. Once assignments are submitted, assignments are often graded by the teachers to reflect the quality of work developed by the student. Because high-quality work is often difficult and/or time-consuming to create, students may be tempted to plagiarize work from pre-existing, high-quality sources. Although plagiarism may save the student effort and time, it defeats the purpose of the assignment as most learning is obtained in the effort and time spent on completing the assignment. Depending on the complexity of the assignment, plagiarism can be detected by the teachers grading the assignment. For example, the quality of an outsourced submission of an assignment may vary from previous assignments submitted by the same student to a degree noticeable by the teacher, and the student may have little knowledge about the assignment and/or the submission when asked. Software programs may also analyze submissions to detect plagiarism by searching databases for phrases from the submission to determine if they exist in published documents.

However, not all forms of academic misconduct can be easily or readily detected. Students may outsource the completion of their assessments to third-party writers, who may themselves write or otherwise create original or seemingly original work. Third-party writers may include individuals, such as other students actively completing the assignment, as well as software programs. Therefore, intelligent strategies for authentication of student submissions that can verify the authorship of submissions are desired.

### SUMMARY

In accordance with one embodiment of the present disclosure, a method for author verification includes extracting, with a processor, text data from an electronic document to produce a plurality of sentences, extracting, with a natural language processing (NLP) tool, a plurality of keywords from the text data, selecting, with the processor, a sentence from the plurality of sentences based on the plurality of keywords, identifying, with the processor, a keyword of the sentence, wherein the keyword is included within the plurality of keywords, and transforming, with the processor and the NLP tool, the keyword into an authentication output provided for display to a user on an electronic display, the authentication output comprising one or more answer options based on the keyword and being selectable by the user via a user input device.

In accordance with another embodiment of the present disclosure, an intelligent assessment tool for author verification includes a processor, a memory communicatively coupled to the processor, a natural language processing (NLP) tool communicatively coupled to the processor having a keyword extraction model, a paraphrasing model, and a part-of-speech tagging model, and a set of machine-readable instructions stored on the memory. The machine-readable instructions, when executed by the processor, direct the processor to perform operations including extracting, with the processor, text data from an electronic document to produce a plurality of sentences, extracting, with the keyword extraction model of the NLP tool, a plurality of keywords from the text data, selecting, with the processor, a sentence from the plurality of sentences based on the plurality of keywords, identifying, with the processor, a keyword of the sentence, wherein the keyword is included within the plurality of keywords, and transforming, with the processor and the NLP tool, the keyword into an authentication output provided for display to a user on an electronic display, the authentication output comprising one or more answer options based on the keyword and being selectable by the user.

In accordance with yet another embodiment of the present disclosure, a non-transitory machine-readable medium has instructions that, when executed by a processor, direct the processor to perform operations including extracting, with the processor, text data from an electronic document to produce a plurality of sentences, extracting, with a natural language processing (NLP) tool, a plurality of keywords from the text data, selecting, with the processor, a sentence from the plurality of sentences based on the plurality of keywords, identifying, with the processor, a keyword of the sentence, wherein the keyword is included within the plurality of keywords, and transforming, with the processor and the NLP tool, the keyword into an authentication output provided for display to a user on an electronic display, the authentication output comprising one or more answer options based on the keyword and being selectable by the user.

Although the concepts of the present disclosure are described herein with primary reference to educational coursework, it is contemplated that the concepts will enjoy applicability to any submission authentication system. For example, and not by way of limitation, it is contemplated that the concepts of the present disclosure will enjoy applicability to submissions for academic journals.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 schematically depicts a diagram of an intelligent assessment tool for author verification, according to one or more embodiments shown and described herein;

FIG. 2 depicts an example system comprising a user computer and a server including the intelligent assessment tool of FIG. 1, according to one or more embodiments shown and described herein;

FIG. 3 depicts a flowchart of an example method of authenticating submissions, according to one or more embodiments shown and described herein;

FIG. 4 depicts an example assignment submission interface, according to one or more embodiments shown and described herein;

FIG. 5 depicts an example style question, according to one or more embodiments shown and described herein;

FIG. 6 depicts an example content question, according to one or more embodiments shown and described herein; and

FIG. 7 depicts an example memory question, according to one or more embodiments shown and described herein.

### DETAILED DESCRIPTION

The embodiments disclosed herein include methods, intelligent assessment tools, and non-transitory computer-readable mediums having instructions for authentication of student submissions. In embodiments disclosed herein, an intelligent assessment tool may be a server that authenticates student submissions. The server may receive an electronic document from a user. The user may be a student and the electronic document may be a submission from the student. The server may extract text data from the electronic document, the text data having a plurality of sentences. From the text data, the server may also extract a plurality of keywords from the plurality of sentences. The server may also select a sentence from the plurality of sentences based on the plurality of keywords. Based on the selected sentence, the server, using a natural language processing (“NLP”) tool, may transform the sentence into an authentication output including a question and one or more answer options based on the keyword and selectable by the user via a user input device. Extracting keywords and selecting sentences based on the keywords helps increase the likelihood that questions for the authentication output generated are not too obvious or irrelevant.

Accordingly, instead of or in addition to searching for the sentence in databases to determine whether a particular sentence is plagiarized, the server quizzes the user in real-time on the user's submission and generates a probability of authorship based on the answer submitted by the user. Stated another way, and as described in further detail herein, the server, as the intelligent assessment tool, creates standardized tests from non-standardized texts (e.g., student submissions). That is, the server creates questions that are adaptable to any text data regardless of its subject matter, lexical style, length, and the like. Accordingly, the server may identify a keyword of a sentence and transform the keyword and/or the sentence into multiple answer options that may be displayed and interacted with by the user. The resulting answer may be weighted to determine the likelihood the person submitting the document actually authored the submitted document.

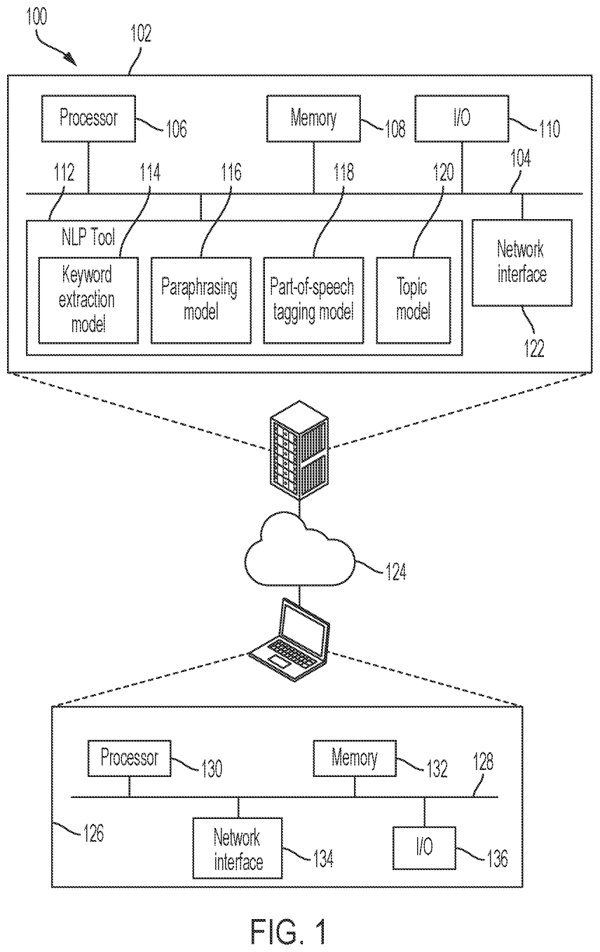

Referring now to FIG. 1, a diagram of a system 100 for author verification comprising a server 102 and a user computer 126 is depicted. The server 102 may include a processor 106, memory 108, NLP tool 112, input/output (I/O) interface 110, and network interface 122. The server 102 may also include a communication path 104 that communicatively couples the various components of the server 102. The server 102 may be a physical server, a virtual machine existing on a server, a program operating on a server, or a component of a server. The server 102 may embody the intelligent assessment tool. That is, the server 102 may be configured to function as an intelligent assessment tool and carry out the methods as described herein.

The processor 106 may include one or more processors that may be any device capable of executing machine-readable and executable instructions. Accordingly, each of the one or more processors of the processor 106 may be a controller, an integrated circuit, a microchip, or any other computing device. The processor 106 is coupled to the communication path 104 that provides signal connectivity between the various components of the server 102. Accordingly, the communication path 104 may communicatively couple any number of processors of the processor 106 with one another and allow them to operate in a distributed computing environment. Specifically, each processor may operate as a node that may send and/or receive data. As used herein, the phrase “communicatively coupled” means that coupled components are capable of exchanging data signals with one another such as, e.g., electrical signals via a conductive medium, electromagnetic signals via air, optical signals via optical waveguides, and the like.

The communication path 104 may be formed from any medium that is capable of transmitting a signal such as, e.g., conductive wires, conductive traces, optical waveguides, and the like. In some embodiments, the communication path 104 may facilitate the transmission of wireless signals, such as Wi-Fi, Bluetooth®, Near-Field Communication (NFC), and the like. Moreover, the communication path 104 may be formed from a combination of mediums capable of transmitting signals. In one embodiment, the communication path 104 comprises a combination of conductive traces, conductive wires, connectors, and buses that cooperate to permit the transmission of electrical data signals to components such as processors, memories, sensors, input devices, output devices, and communication devices. Additionally, it is noted that the term “signal” means a waveform (e.g., electrical, optical, magnetic, mechanical, or electromagnetic), such as DC, AC, sinusoidal-wave, triangular-wave, square-wave, vibration, and the like, capable of traveling through a medium.

The memory 108 is coupled to the communication path 104 and may contain one or more memory modules comprising RAM, ROM, flash memories, hard drives, or any device capable of storing machine-readable and executable instructions such that the machine-readable and executable instructions can be accessed by the processor 106. The machine-readable and executable instructions may comprise logic or algorithms written in any programming language of any generation (e.g., 1GL, 2GL, 3GL, 4GL, or 5GL) such as, e.g., machine language, that may be directly executed by the processor 106, or assembly language, object-oriented languages, scripting languages, microcode, and the like, that may be compiled or assembled into machine-readable and executable instructions and stored on the memory 108. Alternatively, the machine-readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any computer programming language, as pre-programmed hardware elements, or as a combination of hardware and software components.

The input/output interface, or I/O interface 110, is coupled to the communication path 104 and may contain hardware and software for receiving input and/or providing output. Hardware for receiving input may include devices that send information to the server 102. For example, a keyboard, mouse, scanner, and camera are all I/O devices because they provide input to the server 102. Software for receiving inputs may include an on-screen keyboard and a touchscreen. Hardware for providing output may include devices from which data is sent. For example, a monitor, speaker, and printer are all I/O devices because they output data from the server 102.

The NLP tool 112 is coupled to the communication path 104 and may contain one or more models for processing text data. The NLP tool 112 may store electronic documents, and data derived therefrom, received from the user computer 126. The NLP tool 112 also includes machine-readable instructions for the one or more models for processing text data. The NLP tool 112 may contain a keyword extraction model 114, a paraphrasing model 116, a part-of-speech tagging model 118, and/or a topic model 120. The NLP tool 112 may also contain instructions for preprocessing text data for analysis, such as removing stop words, stemming, lemmatization, and the like. In some embodiments, the NLP tool 112 may be included and/or stored in the memory 108.

The keyword extraction model 114 may utilize supervised methods that train a machine learning model based on labeled training sets and uses the trained model to determine whether a word is a keyword, wherein the machine learning model is a decision tree, a Bayes classifier, a support vector machine, a convolutional neural network, and the like. The keyword extraction model 114 may also or instead utilize unsupervised methods that rely on linguistic-based, topic-based, statistics-based, and/or graph-based features of the text data such as text-frequency inverse-document-frequency (TF-IDF), KP-miner, TextRank, Latent Dirichlet Allocation (LDA), and the like.

In embodiments, the paraphrasing model 116 may use supervised machine learning to train a neural network to receive an input and generate an output, where the input may include a keyword and the output may be a sentence based on the keyword. An example paraphrasing model 116 includes, but is not limited to, OpenAI® GPT-4 and Spinbot®. In some embodiments, the input to the paraphrasing model 116 may be the sentence, and the paraphrasing model 116 may rewrite the sentence into the new sentence. In other embodiments, the input to the paraphrasing model 116 may be the keyword, and the paraphrasing model 116 may add words around the keyword to build the new sentence.

The part-of-speech tagging model 118 may include the use of statistical models or supervised machine learning models to mark a word in a text data as corresponding to a particular part of speech based on its definition and context. For example, Markov chain modeling is a statistical method for part-of-speech tagging, and artificial neural networks is a supervised machine learning method for part-of-speech tagging. For example, the part-of-speech tagging model 118 may be used to identify nouns, pronouns, verbs, adjectives, adverbs, articles, or the like. In some embodiments, the part-of-speech tagging model 118 may be used to filter the submission to identify and/or remove parts of speech to determine topics and/or keywords.

The topic model 120 may use unsupervised machine learning to extract the main topics, as represented by keywords, that occur in a text data. For example, LDA is a type of topic model that may be used to classify words in a text data to identify a particular topic of the submission.

It is noted that embodiments of the present disclosure may use a greater or fewer number of models without departing from the scope of the present disclosure.

The network interface 122 includes network connectivity hardware for communicatively coupling the server 102 to the network 124. The network interface 122 can be communicatively coupled to the communication path 104 and can be any device capable of transmitting and/or receiving data via a network 124 or other communication mechanisms. Accordingly, the network interface 122 can include a communication transceiver for sending and/or receiving any wired or wireless communication. For example, the network connectivity hardware of the network interface 122 may include an antenna, a modem, an Ethernet port, a Wi-Fi card, a WiMAX card, a cellular modem, near-field communication hardware, satellite communication hardware, and/or any other wired or wireless hardware for communicating with other networks and/or devices.

The server 102 may be communicatively coupled to the user computer 126 by a network 124. The network 124 may be a wide area network, a local area network, a personal area network, a cellular network, a satellite network, and the like.

The user computer 126 may generally include a processor 130, memory 132, network interface 134, I/O interface 136, and communication path 128. Each user computer 126 component is similar in structure and function to its server 102 counterparts, described in detail above and will not be repeated. The user computer 126 may be communicatively connected to the server 102 via network 124. Multiple user computers may be communicatively connected to one or more servers via network 124.

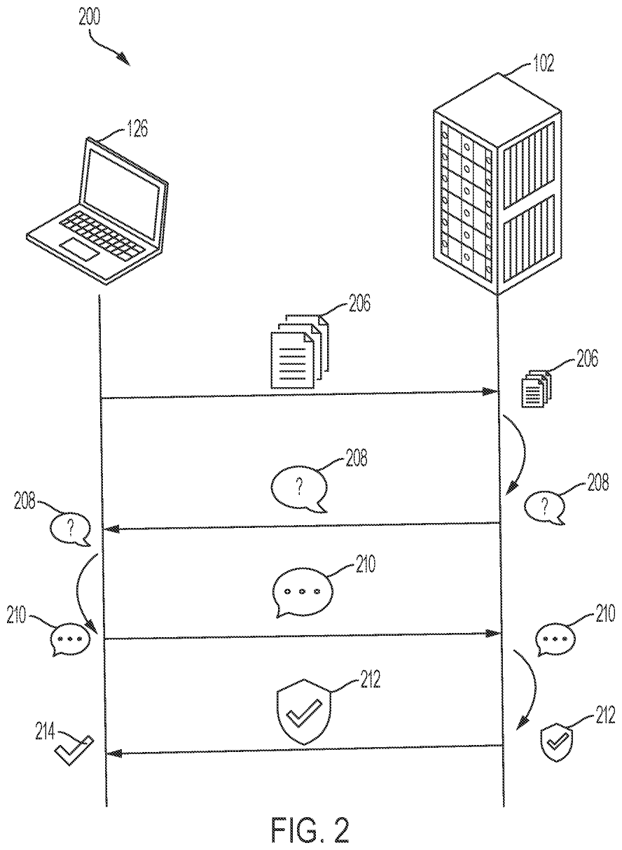

Referring now to FIG. 2, an example system 200 comprising the user computer 126 and the server 102, as described in greater detail above, is depicted. The user computer 126 may be a desktop computer, a laptop computer, a smartphone, a tablet, or any other kind of computing device communicatively coupled to the server 102 as described above. As described in greater detail above, the server 102 embodies an intelligent assessment tool capable of carrying out the methods disclosed herein.

The user computer 126 may be communicatively coupled to the server 102 via the network. While in the example of FIGS. 1 and 2, a single user computer is shown as being communicatively coupled to the server 102, multiple user computers may be communicatively coupled to the server 102. Similarly, while in the example of FIGS. 1 and 2, a single server is shown, multiple servers may be utilized in a distributed computing environment to carry out the methods disclosed herein.

Still referring to FIG. 2, a user (not depicted) may generate an electronic document 206 on the user computer 126. For example, the user may type the electronic document 206 on the user computer 126 and/or upload onto the user computer 126 a document typewritten and/or handwritten into a format of an electronic document 206. For example, a user, using an email, online portal, link, or the like may submit the electronic document 206 to the server 102. The electronic document 206 may be saved on the server 102, such as a memory 108 of the server 102, wherein the electronic document 206 is automatically processed. In particular, the server 102 processes the electronic document 206 to generate an authentication output including one or more questions 208 based on the electronic document 206. That is, portions of the electronic document 206 are transformed into an authentication output including the one or more questions 208 with one or more answer options which may be weighted to determine the likelihood that the user is the author of the submission. The format of the questions 208 may include a style question 500, a content question 600, a memory question 700, and/or the like.

After the electronic document 206 is processed, the server 102 generates and communicates via the network interface 122, for example, to the user computer 126 the authentication output including the one or more questions 208. The purpose of the one or more questions 208 is to determine the user's familiarity with the submitted electronic document 206, for example. The one or more questions 208 may be a number of questions that is fixed or based on features of the electronic document 206, such as the length of the electronic document 206, the complexity of the electronic document 206, etc. For example, longer documents may have a greater number of questions as compared to shorter documents. The questions in the one or more questions 208 may have an associated time limit assigned by the server 102, described below, so that the user does not have time to research the question. The server 102 may also track the user's actions, such as changing windows, to monitor whether the user is attempting to research the question. For example, the web browser may have an event listener to monitor for determining whether a tab or window is active. Accordingly, where it is determined that a user navigates away from the browser while answering the questions, the server 102 may store the time and/or duration of the navigation from the authentication output.

The questions generated by the server 102 may have a variety of forms. For example, the questions may be multiple choice and/or fill-in-the-blank formats. The user may enter a set of user responses 210 to the one or more questions 208 via the I/O interface 136 on the user computer 126, such as a user input device.

After the user enters the set of user responses 210, the user computer 126 may send to the server 102 the set of user responses 210, via the network interface 134. The server 102 may then determine a correctness metric for the one or more of the questions 208. The correctness metric may be based on a comparison of the one or more answer options to the user responses 210. The correctness metric may utilize the lexical distance between the user response and the correct answer. In embodiments, the lexical distance may be Levenshtein distance. For example, the Levenshtein distance between two phrases is the minimum number of single-character edits required to change one phrase into the other, where edits include insertions, deletions, and/or substitutions. The correctness metric may additionally or instead be based on the length of the question, the type of question, the amount of time taken for the user to respond to the question, and any other metric or combination of metrics relating to a user response to a question. The correctness metric may be a point-based system, where points are awarded for corrected answers and partial or no points are awarded for incorrect answers. For example, partial points may be awarded for incorrect answers that have a lexical distance within a predetermined acceptable range, such as a lexical distance of less than 75% of the characters of the correct answer, although other thresholds are contemplated and possible.

After determining the correctness metrics, the server 102 may also generate a verification status report 212. The verification status report 212 may include a probability of authorship, indicating the likelihood that the user is the author of the electronic document 206. The probability of authorship may be based on the number of points awarded compared to the number of points available. In some embodiments, the probability of authorship may be a direct reflection of the number of points awarded. For example, if the user was awarded 75% of possible points, the probability of authorship may be indicated as 75%. The verification status report 212 may also and/or instead include a score, a pass/fail indicator, a list of questions correct, a list of questions incorrect, a list of correct responses, a list of incorrect responses, a list of user responses, and any other information relating to the one or more questions 208 and/or the electronic document 206.

After the server 102 generates the verification status report 212, the server 102 may send to the user computer 126 the verification status report 212. The user computer 126 may process the verification status report 212 to generate a notice 214 for display to the user via the user interface. For example, the notice 214 may include the correctness metric and a statement that the user has been verified as likely being the author of the electronic document 206. In some embodiments, the server 102 may also or instead send the verification status report 212 to a third party, such as the teacher for whom the submission was written.

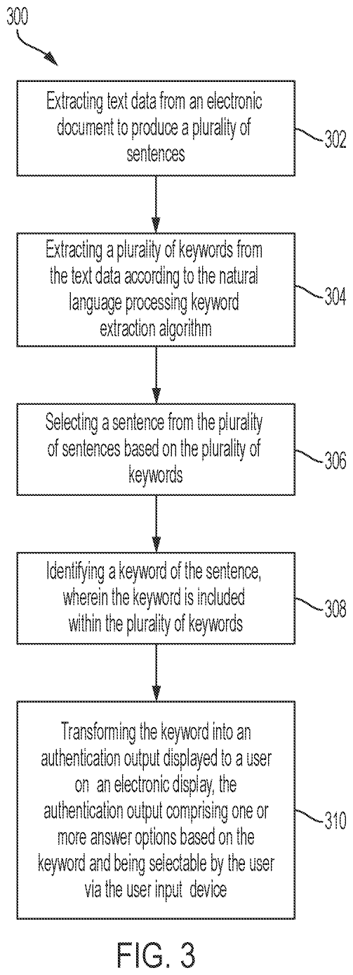

Referring now to FIG. 3, a flowchart of an example method 300 of authenticating submissions is depicted. At step 302, a processor 106 may extract text data from an electronic document 206. The electronic document 206 may be any kind of document in any kind of electronic form. For example, an electronic document 206 may be in a digital text format and/or image formats, such as DOCX, JPEG, PDF, or any other file type capable of storing text and/or images. If the electronic document 206 is in a digital text format, text data may be extracted from the file with a text parsing tool from any available programming language. If the electronic document 206 is in an image format, text data may be generated by the processor 106 performing optical character recognition on the image and parsing text data therefrom. The text data may contain grammatical structures, such as paragraphs and sentences, and the text data may be electronically structured in a similar manner, such as an array of sentences.

At step 304, the NLP tool 112 may extract a plurality of keywords from the text data. As described above, the NLP tool 112 may contain a keyword extraction model 114, a topic model 120, a paraphrasing model 116, and a part-of-speech tagging model 118. To extract keywords, the NLP tool 112 may utilize the keyword extraction model 114 that uses machine learning to break down human language for understanding by machine. Particularly, the keyword extraction model 114 may utilize supervised methods that train a machine learning model based on labeled training sets and utilizes the trained model to determine whether a word is a keyword, wherein the machine learning model is a decision tree, a Bayes classifier, a support vector machine, a convolutional neural network, or the like. The keyword extraction model 114 may also or instead utilize unsupervised methods that rely on linguistic-based, topic-based, statistics-based, and/or graph-based features of the text data, such as text-frequency inverse-document-frequency (TF-IDF), KP-miner, TextRank, Latent Dirichlet Allocation (LDA), and the like.

At step 306, the processor 106 may select a sentence from the plurality of sentences based on the plurality of keywords. The purpose of this selection is to make more meaningful questions due to the more meaningful nature of the sentence the question is based on. Sentences that contain meaningful words or phrases (e.g., keywords) are more likely to make meaningful questions. Meaningful questions are questions that elicit a more thoughtful response from the user and thus are more likely to demonstrate a probability of authorship if answered correctly. For example, in an essay about works of Shakespeare, the sentence, “starting in the 15^{th} century, Shakespeare's poems and plays have been published in many countries and translated into almost all languages” is more meaningful than “they are popular” because it contains more words that are likely to be considered keywords, such as “poems” and “plays,” and that can be the basis for other possible answer choices.

At step 308, the processor 106 may identify a keyword of the sentence, wherein the keyword is included within the plurality of keywords extracted from the text data. Like choosing a meaningful sentence, keywords represent meaningful words that are more likely to generate more meaningful answers options. For example, if an answer option is based on a stop word (e.g., common words such as “the”, “and”, “a”, and the like), the answer option generated could be of any topic unrelated to the submission and thus would be easy for the user to rule out and bias the calculation of the probability of authorship.

At step 310, the processor 106 along with the NLP tool 112 transforms the keyword into an authentication output. The authentication output may include one or more questions each having one or more answer options based on the keyword identified in step 308. In some embodiments, each answer option of each question may be based on the keyword. The authentication output may be displayed to the user on an electronic display of the user computer 126, via I/O interface 136. The questions may be style, content, and/or memory questions, as will be described in greater detail below. One or more answer options of the authentication output may be selectable by the user using a user input device of the user computer 126, via I/O interface 136. In some embodiments, an answer option may be selectable by having a text box for the user to select and type a response. In some embodiments, the authentication output may have a time limit. The time limit may be calculated based on a language proficiency metric, length of the question stem, and/or length of the answer options. The language proficiency metric may be a function of grammatical correctness of the text data, word complexity of the text data, language style of the text data, and any other verbal characteristics of the text data. In some embodiments, the NLP tool 112 may include a syntactic analysis model for determining the language proficiency metric. For example, because the average adult reading speed is approximately 200 words per minute, if the question stem and the answer options are 100 words in total, the time limit may include 30 seconds to read the question stem and the answer options and a fixed 15 seconds to select an answer. In cases where the sentence indicates that the user's language proficiency is non-fluent, then an additional 15 seconds may be added to the time limit to compensate for the lack of fluency, for example.

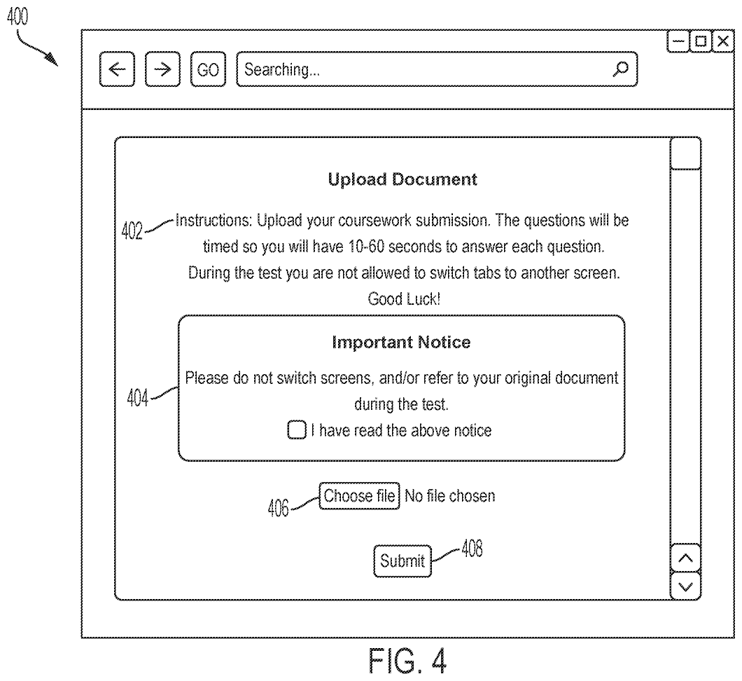

Referring now to FIG. 4, an example assignment submission interface 400 is depicted. The intelligent assessment tool may be built into the server 102 as described above. The server 102 may send files to the user computer 126, and the user computer 126 may generate an interface 400 based on the files. The interface 400 may include instructions 402 to explain to the user how to use the intelligent assessment tool from the user's perspective. For example, the instructions 402 may direct the user to upload a submission and inform the user that the user will be presented with a set of questions based on the submission. The instructions 402 may also indicate a period of time the user has to answer the questions and other restrictions that may be placed on the user during the testing period, such as a requirement not to change to other tabs or windows.

In embodiments, the interface 400 may also include an agreement 404. The agreement 404 may include important notices, such as not to switch screens and/or refer to the submission during the testing, as well as an honor pledge that states that the document submitted is the user's original work. The agreement 404 may include an input, such as a check box or a text box, that the user must affirmatively interact with to demonstrate an affirmation of the agreement 404. Without such affirmation of the agreement 404, the interface 400 may not allow the user to upload the submission.

To upload the submission, the user may also choose a file to upload via a file selection tool 406. The file selection tool 406 may open a file browser for the user to select an electronic document 206 from the user computer 126 that will be sent to the server 102 for processing. In some embodiments, the file selection tool 406 may be a drag-and-drop area for the user to place a file. Once the electronic document 206 has been selected, the user may click a submit button 408 for the user computer 126 to begin uploading the electronic document 206 to the server 102. When the electronic document 206 has been uploaded, the server 102 may perform the method 300 to transform the electronic document 206 into one or more questions 208 that are displayed to the user for the user to respond to.

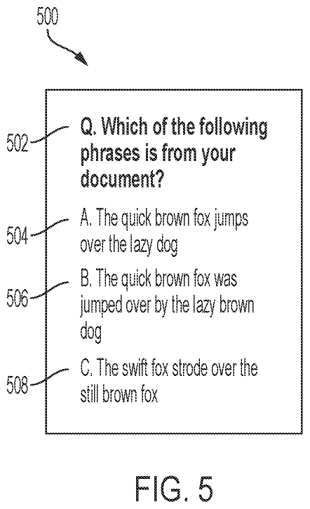

Referring now to FIG. 5, an example style question 500 is depicted. A style question 500 is intended to assess a user's ability to recognize the user's own writing style. The style question may contain a question stem 502 and multiple answer options 504, 506, 508, one of the answer options 504, 506, 508 being a correct answer 504. The answer options 504, 506, 508 may be selectable by the user. Selectability may include interactions such as clicking, drag-and-dropping, manual entry, and any other kind of affirmative user interaction.

To generate a style question 500, an NLP tool 112 of the intelligent assessment tool may determine the topic of the sentence, selected in step 306 of FIG. 3, based on the keyword of the sentence, identified in step 308 of FIG. 3, with a topic model 120. Topic modeling may be the use of unsupervised machine learning to extract the main topics, as represented by keywords, that occur in a text data. For example, LDA is a type of topic model 120 that is used to classify words in a text data to a particular topic. Once a topic has been determined, the NLP tool 112 may generate a new sentence based on the sentence, identified in step 308 of FIG. 3, to be an answer option in the one or more answer options. The NLP tool 112 may include a paraphrasing model 116. The paraphrasing model 116 may use supervised machine learning to train a neural network to receive an input and generate an output, where the input may include a keyword and the output may be a sentence based on the keyword. An example paraphrasing model includes, but is not limited to, OpenAI® GPT-4 and Spinbot®. In some embodiments, the input to the paraphrasing model 116 may be the sentence, and the paraphrasing model 116 rewrites the sentence into the new sentence. In other embodiments, the input to the paraphrasing model 116 may be the keyword, and the paraphrasing model 116 adds words around the keyword to build the new sentence.

For example, as shown in FIG. 5, the question stem 502 asks, “which of the following phrases is from your document?” The answer option 504 is the sentence from the text data extracted from the electronic document 206 submitted by the user, and thus answer option 504 is the correct answer. Answer options 506, 508 may be generated by a paraphrasing model 116 of the NLP tool 112. It should be understood that more than two additional answer options may be generated by the paraphrasing model 116. The correctness metric may include the lexical distance between the selected answer option and the answer. The lexical distance between two phrases is the number of deletions, insertions, or substitutions required to transform the chosen answer option to the answer. If the user selects answer option 506, the lexical distance between answer option 506 and answer option 504 is 15. If the user selects answer option 508, the lexical distance between answer option 508 and answer option 504 is 28. Because answer option 506 has a lower lexical distance to the answer 504 than answer option 508, selecting answer option 506 would result in a better correctness metric for question 500 than selecting answer option 508. For example, answer option 506 may be worth a half point because the lexical distance is less than 50% of the character length of the correct answer (i.e., 15/43), whereas answer option 508 may be worth no points because the lexical distance is greater than 50% of the character length of the correct answer (i.e., 28/43). However, selecting answer option 504 would result in the best correctness metric for question 500, such as a full point, because answer option 504 is the correct answer.

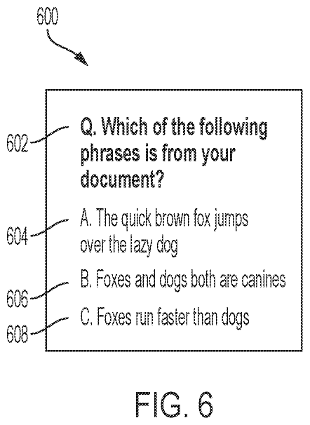

Referring now to FIG. 6, an example content question 600 is depicted. A content question 600 is intended to assess a user's ability to recognize the user's own content. The content question 600 may contain a question stem 602 and multiple answer options 604, 606, 608, one of the answer options 604, 606, 608 being a correct answer 604. The answer options 604, 606, 608 may be selectable by the user. Selectability may include interactions such as clicking, drag-and-dropping, manual entry, and any other kind of affirmative user interaction. The answer options 604, 606, 608 may be assigned a score based on their lexical distance to the correct answer, where the score may be based on ranges of lexical distances.

To generate a content question 600, an NLP tool 112 of the intelligent assessment tool may determine the topic of the sentence, selected in step 306 of FIG. 3, based on the keyword of the sentence, identified in step 308 of FIG. 3, with a topic model 120. Topic modeling may include the use of unsupervised machine learning to extract the main topics, as represented by keywords, that occur in a text data. For example, LDA is a type of topic model that is used to classify words in a text data to a particular topic. Once a topic has been determined, the processor 106 may extract reference text data from a reference document to produce a plurality of reference sentences. The reference document is a document other than the user submission. For example, the reference document may be a submission by another user for the same assignment. Once the reference text data has been extracted, the processor 106 may select a new sentence from the plurality of reference sentences to be an answer option in the one or more answer options. The selection may be based on the topic and/or the keyword to ensure that the new sentence, that becomes an answer option, is not so unrelated from the sentence, identified in step 308 of FIG. 3, that it would be obvious for the user to disregard the new sentence as a possible answer.

For example, as shown in FIG. 6, the question stem 602 asks, “which of the following phrases is from your document?” The answer option 604 is the sentence from the text data extracted from the electronic document 206 submitted by the user, and thus answer option 604 is the correct answer. Answer options 606, 608 may be generated by a topic model 120 of the NLP tool 112. It should be understood that more than two additional answer options may be generated by the topic model 120. The correctness metric may include the lexical distance between the selected answer option and the answer. If the user selects answer option 606, the lexical distance between answer option 606 and answer option 604 is 34. If the user selects answer option 608, the lexical distance between answer option 608 and answer option 604 is 28. Because answer option 608 has a lower lexical distance to the answer 604 than answer option 606, selecting answer option 608 would result in a better correctness metric for question 600 than selecting answer option 606. For example, answer option 608 may be worth a half point because the lexical distance is less than 75% of the character length of the correct answer (i.e., 28/43), whereas answer option 508 may be worth no points because the lexical distance is greater than 75% of the character length of the correct answer (i.e., 34/43). However, selecting answer option 604 would result in the best correctness metric for question 600, such as a full point, because answer option 604 is the correct answer.

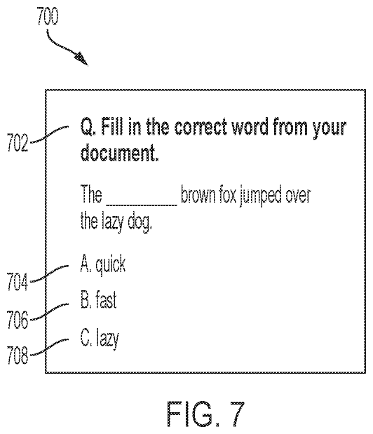

Referring now to FIG. 7 an example memory question 700 is depicted. A memory question 700 is intended to assess a user's memory of their submission. The memory question 700 may contain a question stem 702 and multiple answer options 704, 706, 708, one of the answer options 704, 706, 708 being a correct answer 704. The answer options 704, 706, 708 may be selectable by the user. Selectability may include interactions such as clicking, drag-and-dropping, manual entry, and any other kind of affirmative user interaction.

To generate a memory question 700, an NLP tool 112 of the intelligent assessment tool may determine a part of speech of the keyword, identified in step 308 of FIG. 3, with a part-of-speech tagging model 118 of the NLP tool 112. The part-of-speech tagging model 118 may include the use of statistical models or supervised machine learning models to mark a word in a text data as corresponding to a particular part of speech based on its definition and context. For example, Markov chain models are statistical models for part-of-speech tagging, and artificial neural networks are supervised machine learning models for part-of-speech tagging. The NLP tool 112 of the intelligent assessment tool may also determine the topic of the text data based on the plurality of keywords of the sentence, identified in step 304 of FIG. 3, with a topic model 120. Topic modeling may include the use of unsupervised machine learning to extract the main topics, as represented by keywords, that occur in a text data. For example, LDA is a type of topic model that is used to classify words in a text data to a particular topic. Once the part-of-speech and topic of the text have been determined, the processor 106 may generate a word option based on the keyword, the part of speech, and/or the topic. The word option is an answer option in the one or more answer options. The remaining answer options may be different words of the same part of speech. For example, if the generated word option of “the quick brown fox jumped over the lazy dog” is “jumped,” the remaining answer options may be verbs such as “skipped,” “hopped,” “ran,” and the like. The remaining answer options are based on the same part-of-speech to ensure that the remaining answer options are not so unrelated from the generated word option that it would be obvious for the user to disregard the remaining answer options as possible answers.

For example, as shown in FIG. 7, the question stem 702 states, “fill in the correct word from your document” and “the brown fox jumped over the lazy dog.” The answer option 704 is the word from a sentence of the text data, and thus answer option 704 is the correct answer. Answer options 706, 708 may be generated based on the keyword, the part of speech, and/or the topic of the text data as determined by the NLP tool 112. It should be understood that more than two additional answer options may be generated. The correctness metric may include the lexical distance between the selected answer option and the answer. If the user selects answer option 706, the lexical distance between answer option 706 and answer option 704 is 5. If the user selects answer option 708, the lexical distance between answer option 708 and answer option 704 is 5. Because answer option 708 has the same lexical distance to the answer 704 as answer option 706, selecting either answer option 706 or answer option 708 could result in the same correctness metric for question 700, although they are both incorrect. For example, answer options 706, 708 may be worth a half point because the lexical distance is more than 75% of the character length of the correct answer (i.e., 5/5). However, selecting answer option 704 would result in the best correctness metric for question 700, such as a full point, because answer option 704 is the correct answer.

It should now be understood that embodiments disclosed herein include methods, intelligent assessment tools, and non-transitory computer-readable mediums having instructions for authentication of student submissions. The embodiments may receive an electronic document from a user. The user may represent a student and the electronic document may represent a submission from the student. Embodiments may extract text data from the electronic document, the text data having a plurality of sentences. From the text data, embodiments may also extract a plurality of keywords from the plurality of sentences. Embodiments may also select a sentence from the plurality of sentences based on the plurality of keywords. Based on the selected sentence, a keyword may be identified and transformed into an authentication output comprising answer options. One or more of the answer options are based on the keyword. The user may select a response from the answer options. Based on the user's responses, embodiments may generate a correctness metric to determine the probability that the user was the author of the electronic document. Accordingly, teachers, institutions, and the like may quickly and easily verify the authorship of a submitted work.

It is noted that recitations herein of a component of the present disclosure being “configured” or “programmed” in a particular way, to embody a particular property, or to function in a particular manner, are structural recitations, as opposed to recitations of intended use. More specifically, the references herein to the manner in which a component is “configured” or “programmed” denotes an existing physical condition of the component and, as such, is to be taken as a definite recitation of the structural characteristics of the component.

It is noted that terms like “preferably,” “commonly,” and “typically,” when utilized herein, are not utilized to limit the scope of the claimed invention or to imply that certain features are critical, essential, or even important to the structure or function of the claimed invention. Rather, these terms are merely intended to identify particular aspects of an embodiment of the present disclosure or to emphasize alternative or additional features that may or may not be utilized in a particular embodiment of the present disclosure.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

What is claimed is:

1. A method for author verification, comprising:
extracting, with a processor, text data from an electronic document to produce a plurality of sentences;
extracting, with a natural language processing (NLP) tool, a plurality of keywords from the text data;
selecting, with the processor, a sentence from the plurality of sentences based on the plurality of keywords;
identifying, with the processor, a keyword of the sentence, wherein the keyword is included within the plurality of keywords; and
transforming, with the processor and the NLP tool, the keyword into an authentication output provided for display to a user on an electronic display, the authentication output comprising one or more answer options based on the keyword and being selectable by the user via a user input device.

2. The method of claim 1, wherein transforming the keyword into the authentication output comprises:
determining, with the NLP tool, a topic of the sentence based on the keyword of the sentence; and
generating, with the NLP tool, a new sentence based on the sentence such that the new sentence has the keyword and the topic, the new sentence being an answer option in the one or more answer options.

3. The method of claim 1, wherein transforming the keyword into the authentication output comprises:
determining, with the NLP tool, a topic of the sentence based on the keyword of the sentence;
extracting, with the processor, reference text data from a reference document to produce a plurality of reference sentences; and
selecting, with the processor, a new sentence from the plurality of reference sentences based on the topic and the keyword, the new sentence being an answer option in the one or more answer options.

4. The method of claim 1, wherein transforming the keyword into the authentication output comprises:
determining, with the NLP tool, a part of speech of the keyword;
determining, with the NLP tool, a topic of the text data based on the plurality of keywords; and
generating, with the processor, a word option based on at least one of the keyword, the part of speech, and the topic, the word option being an answer option in the one or more answer options.

5. The method of claim 1, further comprising:
receiving, with the processor, one or more user responses corresponding to the authentication output;
determining, with the processor, one or more correctness metrics for the authentication output based on a comparison of the one or more answer options to the one or more user responses; and
generating, with the processor, an author verification status report based on the one or more correctness metrics of the one or more user responses.

6. The method of claim 5, wherein the one or more correctness metrics is based on a lexical distance between the one or more answer options and the one or more user responses.

7. The method of claim 5, further comprising determining, with the processor, a probability of authorship based on the one or more correctness metrics for the authentication output.

8. The method of claim 1, further comprising calculating, with the processor, a time limit for the authentication output, wherein the time limit is based on a language proficiency metric of the text data, a length of the sentence, a number of answer options, or combinations thereof.

9. An intelligent assessment tool for author verification, comprising:
a processor;
a memory communicatively coupled to the processor;
a natural language processing (NLP) tool communicatively coupled to the processor having a keyword extraction model, a paraphrasing model, and a part-of-speech tagging model; and
a set of machine-readable instructions stored in the memory that, when executed by the processor, direct the processor to perform operations comprising:
extracting, with the processor, text data from an electronic document to produce a plurality of sentences;
extracting, with the keyword extraction model of the NLP tool, a plurality of keywords from the text data;
selecting, with the processor, a sentence from the plurality of sentences based on the plurality of keywords;
identifying, with the processor, a keyword of the sentence, wherein the keyword is included within the plurality of keywords; and
transforming, with the processor and the NLP tool, the keyword into an authentication output provided for display to a user on an electronic display, the authentication output comprising one or more answer options based on the keyword and being selectable by the user.

10. The intelligent assessment tool of claim 9, wherein transforming the keyword into the authentication output comprises:
determining, with a topic model of the NLP tool, a topic of the sentence based on the keyword of the sentence; and
generating, with the paraphrasing model of the NLP tool, a new sentence based on the sentence such that the new sentence has the keyword and the topic, the new sentence being an answer option in the one or more answer options.

11. The intelligent assessment tool of claim 9, wherein transforming the keyword into the authentication output comprises:
determining, with the part-of-speech tagging model of the NLP tool, a topic of the sentence based on the keyword of the sentence;
extracting, with the processor, reference text data from a reference document to produce a plurality of reference sentences; and
selecting, with the processor, a new sentence from the plurality of reference sentences based on the topic and the keyword, the new sentence being an answer option in the one or more answer options.

12. The intelligent assessment tool of claim 9, wherein transforming the keyword into the authentication output comprises:
determining, with the part-of-speech tagging model of the NLP tool, a part of speech of the keyword;
determining, with a topic model of the NLP tool, a topic of the text data based on the plurality of keywords; and
generating, with the processor, a word option based on at least one of the keyword, the part of speech, and the topic, the word option being an answer option in the one or more answer options.

13. The intelligent assessment tool of claim 9, wherein the operations further comprise:
receiving, with the processor, one or more user responses corresponding to the authentication output;
determining, with the processor, one or more correctness metrics for the authentication output based on a comparison of the one or more answer options to the one or more user responses; and
generating, with the processor, an author verification status report based on the one or more correctness metrics of the one or more user responses.

14. The intelligent assessment tool of claim 13, wherein the one or more correctness metrics is based on a lexical distance between the one or more answer options and the one or more user responses.

15. The intelligent assessment tool of claim 13, wherein the operations further comprise determining, with the processor, a probability of authorship based on the one or more correctness metrics for the authentication output.

16. The intelligent assessment tool of claim 9, wherein the operations further comprise calculating, with the processor, a time limit for the authentication output, wherein the time limit is based on a language proficiency metric of the text data, a length of a question stem, a length of answer options, or combinations thereof

17. A non-transitory machine-readable medium having instructions that, when executed by a processor, direct the processor to perform operations comprising:
extracting, with the processor, text data from an electronic document to produce a plurality of sentences;
extracting, with a natural language processing (NLP) tool, a plurality of keywords from the text data;
selecting, with the processor, a sentence from the plurality of sentences based on the plurality of keywords;
identifying, with the processor, a keyword of the sentence, wherein the keyword is included within the plurality of keywords; and
transforming, with the processor and the NLP tool, the keyword into an authentication output provided for display to a user on an electronic display, the authentication output comprising one or more answer options based on the keyword and being selectable by the user.

18. The non-transitory machine-readable medium of claim 17, wherein transforming the keyword into the authentication output comprises:
determining, with the NLP tool, a topic of the sentence based on the keyword of the sentence; and
generating, with the NLP tool, a new sentence based on the sentence such that the new sentence has the keyword and the topic, the new sentence being an answer option in the one or more answer options.

19. The non-transitory machine-readable medium of claim 17, wherein transforming the keyword into the authentication output comprises:
determining, with the NLP tool, a topic of the sentence based on the keyword of the sentence;
extracting, with the processor, reference text data from a reference document to produce a plurality of reference sentences; and
selecting, with the processor, a new sentence from the plurality of reference sentences based on the topic and the keyword, the new sentence being an answer option in the one or more answer options.

20. The non-transitory machine-readable medium of claim 17, wherein transforming the keyword into the authentication output comprises:
determining, with the NLP tool, a part of speech of the keyword;
determining, with the NLP tool, a topic of the text data based on the plurality of keywords; and
generating, with the processor, a word option based on at least one of the keyword, the part of speech, and the topic, the word option being an answer option in the one or more answer options.

21. The non-transitory machine-readable medium of claim 17, wherein the operations further comprise:
receiving, with the processor, one or more user responses corresponding to the authentication output;
determining, with the processor, one or more correctness metrics for the authentication output based on a comparison of the one or more answer options to the one or more user responses; and
generating, with the processor, an author verification status report based on the one or more correctness metrics of the one or more user responses.

22. The non-transitory machine-readable medium of claim 21, wherein the operations further comprise determining, with the processor, a probability of authorship based on the one or more correctness metrics for the authentication output.

23. The non-transitory machine-readable medium of claim 17, wherein the operations further comprise calculating, with the processor, a time limit for the authentication output, wherein the time limit is based on a language proficiency metric of the text data, a length of a question stem, a length of answer options, or combinations thereof.
